(19) United States
(12) Patent Application Publication
(10) Pub. No.: US 2025/0254374 A1
(43) Pub. Date: Aug. 7, 2025

(54) METHOD AND APPARATUS FOR SCENE ANALYSIS IN CONTENT STREAMING SYSTEM

(71) Applicant: TVING CO., LTD., Seoul (KR)

(72) Inventors: Seong Cheol JO, Yongin (KR); Gun Mo GOO, Chuncheon (KR)

(21) Appl. No.: 19/189,036

(22) Filed: Apr. 24, 2025

Related U.S. Application Data
(63) Continuation of application No. PCT/KR2023/015701, filed on Oct. 12, 2023.

(30) Foreign Application Priority Data
Oct. 28, 2022 (KR) 10-2022-0141540

(51) Int. Cl. H04N 21/231; G06V 10/74; G06V 10/774; G06V 20/40; G11B 27/34; H04N 21/234; H04N 21/239; H04N 21/266; H04N 21/437

(52) U.S. Cl. CPC H04N 21/23109; G06V 10/761; G06V 10/774; G06V 20/44; G11B 27/34; H04N 21/23418; H04N 21/2393; H04N 21/266; H04N 21/437

(57) ABSTRACT

Disclosed herein are a method for analyzing a scene in a content streaming system and an apparatus thereof, and the method for analyzing a scene in a content streaming system may include receiving a request for generating a bookmark scene, analyzing a target scene in the content image by image processing based on the request to generate the bookmark scene, and storing the generated bookmark scene in a scene library.

### CROSS-REFERENCE TO RELATED APPLICATIONS

This application is a bypass continuation application claiming a benefit of an International Application PCT/KR2023/015701 filed on Oct. 12, 2023 and claiming priority based on Korean Patent Application No. 10-2022-0141540 filed on Oct. 28, 2022, the disclosures of which are incorporated herein by reference in their entireties.

### TECHNICAL FIELD

The present disclosure relates to a content streaming system, and more particularly, to a method and apparatus for analyzing a scene in a content streaming system.

### BACKGROUND ART

With the development of various technologies and changes in consumption trends, a great change has occurred in the way content is supplied and consumed. The development of digital technology, computer technology, Internet/communication technology, etc. has blurred the boundaries of the type of content and the subject of production, which has caused a great change in the creation and consumption patterns of content. Platforms have emerged that allow ordinary people to create and distribute content. In addition, ease of access to various contents has been secured, and various options for consumption methods have begun to be provided.

Among these many changes in the content industry, OTT (over the top) services exist. OTT service is a media platform based on Internet and mobile communication, and provides various contents to consumers without equipment such as a separate set-top box beyond existing broadcasting services. The concept of OTT service started by providing movies and television programs in the form of video on demand (VOD), but the OTT service is still expanding, by not only providing content created by OTT service providers but also expanding its scope to mobile platforms.

### DISCLOSURE

### Technical Problem

The present disclosure is directed to providing a method and device for real-time scene analysis according to a bookmark request in a content streaming system.

The present disclosure is directed to providing a method and device for ranking a scene stored in a server in a content streaming system.

The present disclosure is directed to providing a method and device for ranking a scene similar to a scene stored in a scene library in a content streaming system.

The technical problems solved by the present disclosure are not limited to the above technical problems and other technical problems which are not described herein will be clearly understood by a person having ordinary skill in the technical field, to which the present disclosure belongs, from the following description.

### Technical Solution

According to an embodiment of the present disclosure, a method for analyzing a scene in a content streaming system may include receiving a request for generating a bookmark scene, analyzing a target scene in the content image by image processing based on the request to generate the bookmark scene, and storing the generated bookmark scene in a scene library, and the analyzing of the scene may include determining a change time of the scene.

According to an embodiment of the present disclosure, the change time point of scene change in the target scene may be determined based on a degree of similarity between frames of the target scene.

According to an embodiment of the present disclosure, the degree of similarity between the frames may be determined further based on a degree of similarity of pixels or pixel groups between the frames.

According to an embodiment of the present disclosure, the analyzing of the target scene may further include analyzing the target scene by using a trained artificial intelligence (AI) model, and the AI model may be trained by using at least one of a set of training images and associated time point information of scene change within the training images.

According to an embodiment of the present disclosure, the AI model may be trained by using at least one theme label corresponding to each frame.

According to an embodiment of the present disclosure, when a first frame with a first theme label changes in order of playback time to a second frame with a second theme label, the second frame with the second theme label is determined as a frame of a scene change time.

According to an embodiment of the present disclosure, the theme label may be given based on at least one of audio data, a specific actor, a specific action, a specific OST, a specific BGM, or a specific place.

According to an embodiment of the present disclosure, the method may further include analyzing a first theme label of an in-library scene stored in the scene library, analyzing a second theme label of in-server scenes stored in a server, giving a ranking score to a ranking scene from among the in-server scenes stored in the server by comparing the first theme label and the second theme label, adding up the ranking score given to the ranking scene from among the in-server scenes stored in the server, and displaying the ranking scene from among the in-server scenes stored in the server in descending order of the added-up ranking score.

According to an embodiment of the present disclosure, the method may further include receiving a request for generating a popular section in the content image from a terminal and transmitting popular section information based on the request for generating the popular section to the terminal, and the request for generating the bookmark scene may be generated based on the popular section information, and the popular section information may be information on a popular section determined based on at least one of the number of accumulated scene views or the number of scene saves in the content image.

According to an embodiment of the present disclosure, the method may further include determining at least one representative scene based on the number of scene saves, the number of scene hits, scene feedback information, and the like, when the target scene is not analyzed based on the request for generating the bookmark scene, identifying a representative scene corresponding to the request for generating the bookmark scene, and storing the identified representative scene in the scene library.

According to an embodiment of the present disclosure, the determining of the at least one representative scene may include, when the number of overlapping similar scenes among similar scenes stored through the request for generating the bookmark scene is equal to or greater than a predetermined threshold, determining the representative scene as the overlapping similar scenes.

According to an embodiment of the present disclosure, the storing of the generated bookmark scene in the scene library may include transmitting information on the generated bookmark scene to a terminal, receiving a storage request based on a user input indicating modification of the generated bookmark scene from the terminal, and storing the modified bookmark scene based on the storage request in the scene library, and the storage request includes information indicating at least one of a modified start time and a modified end time of the generated bookmark scene.

According to an embodiment of the present disclosure, the method may further include receiving a scene library access request from a second user terminal, after the second user terminal receives a share approval signal from a first user terminal and transmitting information on the scene library associated with a user of the first user terminal to the second user terminal according to the scene library access request.

According to an embodiment of the present disclosure, a method for storing a scene in a content streaming system may include transmitting a bookmark generation request of a user to a server, receiving information on a scene analyzed based on the bookmark generation request from the server, and based on the information on the scene, transmitting a request for storing the scene in a scene library to the server.

According to an embodiment of the present disclosure, the information on the scene may include 1) a start time of the scene and 2) information on a difference between an end time of the scene, in association with a change time of the scene, and the start time, and the transmitting of the request for storing the scene in the scene library based on the information on the scene may include receiving, based on the information on the scene, a user input associated with modification of at least one of the start time and the end time of the scene and transmitting a request for storing in the scene library based on the user input to the server.

The features briefly summarized above with respect to the present disclosure are merely exemplary aspects of the detailed description of the present disclosure that follows, and do not limit the scope of the present disclosure.

### Effects of Invention

According to the present disclosure, it is possible to effectively analyze a scene stored in a scene library in a content streaming system.

According to the present disclosure, it is possible to perform scene analysis in real time according to a bookmark generation request of a user in a content streaming system.

According to the present disclosure, it is possible to store a scene desired by a user in a library.

According to the present disclosure, it is possible to calculate a scene ranking in a content streaming system.

It will be appreciated by persons skilled in the art that the effects that can be achieved through the present disclosure are not limited to what has been particularly described hereinabove and other advantages not mentioned herein will be clearly understood from the detailed description below.

### DESCRIPTION OF DRAWINGS

FIG. 1 illustrates a content streaming system according to an embodiment of the present disclosure.

FIG. 2 illustrates a structure of a client device according to an embodiment of the present disclosure.

FIG. 3 illustrates a structure of a server according to an embodiment of the present disclosure.

FIG. 4 illustrates the concept of a content streaming service according to an embodiment of the present disclosure.

FIG. 5 illustrates a procedure of receiving popular section information according to an embodiment of the present disclosure.

FIG. 6A illustrates popular section information according to an embodiment of the present disclosure.

FIG. 6B illustrates a modification screen of an analyzed scene according to an embodiment of the present disclosure.

FIG. 7 illustrates a scene analysis procedure based on a bookmark generation request according to an embodiment of the present disclosure.

FIG. 8 illustrates a flowchart of a scene analysis method according to an embodiment of the present disclosure.

FIG. 9 illustrates a flowchart of a scene analysis method according to an embodiment of the present disclosure.

FIG. 10 illustrates an example of storing in a scene library according to an embodiment of the present disclosure.

FIG. 11 illustrates an example of real-time scene analysis according to an embodiment of the present disclosure.

FIG. 12 illustrates an example of storing an already extracted scene according to an embodiment of the present disclosure.

FIG. 13 illustrates an example of extracting a representative scene according to an embodiment of the present disclosure.

FIG. 14 illustrates a flowchart of a method of ranking a scene according to an embodiment of the present disclosure.

FIG. 15 illustrates a procedure of sharing a scene library according to an embodiment of the present disclosure.

### MODE FOR INVENTION

Hereinafter, embodiments of the present disclosure will be described in detail with reference to the accompanying drawings so that those skilled in the art can easily carry out the present disclosure. However, the present disclosure may be embodied in many different forms and is not limited to the embodiments set forth herein.

In describing the embodiments of the present disclosure, a detailed description of known configurations or functions will be omitted when it may obscure the subject matter of the present disclosure. In the drawings, parts not related to the description of the present disclosure are omitted, and similar reference numerals denote similar parts.

The functional blocks shown in the drawings and described below are only examples of possible implementations. Other functional blocks may be used in other implementations without departing from the spirit and scope of the detailed description. Additionally, although one or more functional blocks of the present disclosure are represented as separate blocks, one or more of the functional blocks of the present disclosure may be a combination of various hardware and software configurations that perform the same function.

In addition, the expression of including certain components is an expression of “open type” and simply indicates that the corresponding components are present, and should not be understood as excluding additional components. Furthermore, when a component is referred to as being “connected” or “coupled” to another component, it should be understood that it may be directly connected or coupled to the other component or intervening components may also be present.

In addition, a singular expression for an object may be understood as a plural expression, unless the context clearly indicates otherwise. In the present disclosure, expressions such as “A or B” or “at least one of A and/or B” may be understood to include all possible combinations of the items listed together. Expressions such as “first”, “second”, and “third” may modify the object regardless of order or importance, and are used only to distinguish one object from other objects of the same kind.

In addition, in the present disclosure, “configured to” may be understood as having the meaning technically equivalent to any one of expressions of “suitable for”, “having the ability to”, “changed to”, “made to”, “capable of” and “designed to” in terms of hardware or software, depending on the situation, and may be replaced with each other.

The present disclosure is to provide a method and apparatus for analyzing and storing scene in a content streaming system. Specifically, techniques are described for storing user-desired scenes in a scene library, sharing them with other users, and displaying scenes suitable for the user's preference based on scenes stored in the scene library.

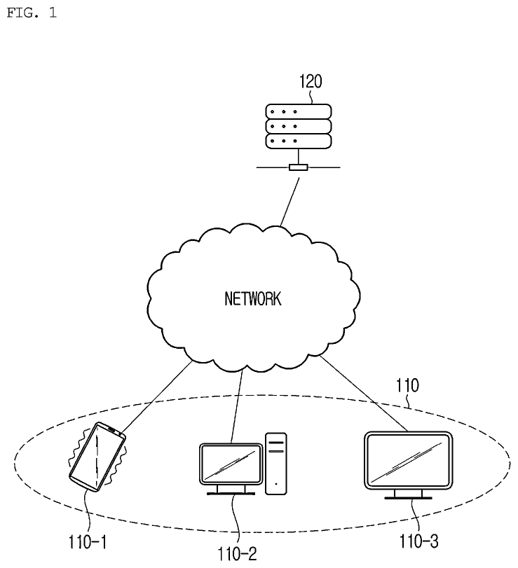

FIG. 1 illustrates a content streaming system according to an embodiment of the present disclosure. FIG. 1 illustrates a system for providing services related to content, such as content streaming and content-related information provision, and entities belonging to the system. Hereinafter, in the present disclosure, various services related to content may be referred to as ‘content service’ or other terms having equivalent technical meaning.

Referring to FIG. 1, the content streaming system may include a client device 110 and a server 120. Here, the client device 110 is illustrated as a set of three client devices 110-1 to 110-3, but the content streaming system may include two or less or four or more client devices. In addition, although one server 120 is illustrated, the content streaming system may include a plurality of servers that share various functions and interact with each other.

The client device 110 receives and displays content. The client device 110 may receive content streamed from the server 120 after accessing the server 120 through a network. That is, the client device 110 is hardware on which client software or applications designed to use the content service provided by the server 120 are installed, and may interact with the server 120 through the installed software or applications. The client device 110 may be implemented as various types of devices. For example, the client device 110 may be one of a movable portable device, a device that is movable but generally fixed during use, and a device that is fixedly installed at a specific location.

Specifically, the client device 110 may be implemented in the form of at least one of a smartphone 110-1, a desktop computer 110-2, a tablet PC, a laptop PC, a netbook computer, a workstation, a server, a personal data assistant (PDA), a portable multimedia player (PMP), a camera, or a wearable device. Here, the wearable device may be implemented in the form of at least one of an accessory type (e.g., watch, ring, bracelet, anklet, necklace, glasses, contact lens, HMD (head-mounted-device)), clothing type, body attachment type (e.g., skin pad or tattoo), or bio implantable circuit. In addition, the client device 110 is a home appliance, and may be, for example, implemented in the form of at least one of a television 110-3, a digital video disk (DVD) player, an audio system, a refrigerator, an air conditioner, a vacuum cleaner, an oven, a microwave oven, a washing machine, or an air purifier.

The server 120 performs various functions to provide content services. In other words, the server 120 may provide services related to content streaming and various contents to the client device 110 using various functions. Specifically, the server 120 may perform datafication to stream content, and transmit the content to the client device 110 through a network. To this end, the server 120 may perform at least one of content encoding, data segmentation, transmission scheduling, or streaming transmission. Additionally, for the convenience of content use, the server 120 may further perform at least one function of providing a content guide, managing a user's account, analyzing a user preference, or recommending content based on preference. A plurality of functions among the various functions described above may be provided, and for this purpose, the server 120 may be implemented as a plurality of servers.

The client device 110 and the server 120 exchange information through a network, and a content service may be provided to the client device 110 based on the exchanged information. In this case, the network may be a single network or a combination of various types of networks. The network may be understood as a form in which different types of networks are connected according to regions. For example, the networks may include at least one of a wireless network or a wired network. Specifically, the networks include a cellular network based on at least one of 6^{th} generation (6G), 5^{th} generation (5G), long term evolution (LTE), LTE Advance (LTE-A), code division multiple access (CDMA), wideband CDMA (WCDMA), and universal mobile telecommunications system (UMTS), wireless broadband (WiMAX), or Global System for Mobile Communications (GSM). Also, the networks may include a local area network based on at least one of a wireless local area network (WLAN), Bluetooth, Zigbee, near field communication (NFC), or ultra wideband (UWB). In addition, the networks may include wired networks such as the Internet and Ethernet.

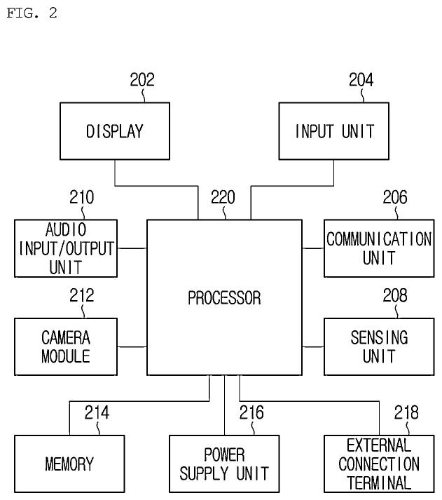

FIG. 2 illustrates a structure of a client device according to an embodiment of the present disclosure. FIG. 2 illustrates a block structure of a client device (e.g., the client device 110 of FIG. 1).

Referring to FIG. 2, the client device includes a display 202, an input unit 204, a communication unit 206, a sensing unit 208, an audio input/output unit 210, a camera module 212, a memory 214, a power supply unit 216, an external connection terminal 218 and a processor 220. However, depending on the type of device, at least one of the components illustrated in FIG. 2 may be omitted.

The display 202 outputs information such as visually recognizable images and graphics. To this end, the display 202 may include a panel and a circuit for controlling the panel. For example, the panel may include at least one of a liquid crystal display (LCD), a light emitting diode (LED), a light emitting polymer display (LPD), an organic light emitting diode (OLED), an active matrix organic light emitting diode (AMOLED) or a flexible LED (FLED).

The input unit 204 receives input generated by a user. The input unit 204 may include various types of input sensing units. For example, the input unit 204 may include at least one of a physical button, a keypad or a touch pad. Alternatively, the input unit 204 may include a touch panel. When the input unit 204 includes a touch panel, the input unit 204 and the display 202 may be implemented as one module.

The communication unit 206 provides an interface for enabling a client device to form a network with other devices and to transmit or receive data through the network. To this end, the communication unit 206 may include a circuit for physically processing signals (e.g., an encoder/decoder, a modulator/demodulator, a radio frequency (RF) front end, etc.), a protocol stack for processing data according to communication standards (e.g., modem), etc. According to various embodiments, the communication unit 206 may include a plurality of modules to support a plurality of different communication standards.

The sensing unit 208 collects sensing data including data on the state of the client device or the surrounding environment. For example, the sensing unit 208 may measure a physical value or a change in value related to an operating state or posture of the client device, and generate an electrical signal representing the measured result. In addition, the sensing unit 208 may measure a physical value or a change in value of the surrounding environment of the client device and generate an electrical signal representing the measured result. To this end, the sensing unit 208 may include at least one sensor and a circuit for controlling the at least one sensor. Specifically, the sensing unit 208 may include at least one of a gyro sensor, a magnetic sensor, an acceleration sensor, a grip sensor, a proximity sensor, a color sensor, a bio sensor, an air pressure sensor, a temperature sensor, a humidity sensor, an illuminance sensor, or an ultra violet (UV) sensor, an e-nose sensor, a gesture sensor, an electromyography (EMG) sensor, an electroencephalogram (EEG) sensor, an electrocardiogram (ECG) sensor, an infrared (IR) sensor, an iris sensor, or a fingerprint sensor.

The audio input/output unit 210 outputs sound according to electrical signals generated based on audio data and detects external sound. That is, the audio input/output unit 210 may convert sound and electrical signals into each other. To this end, the audio input/output unit 210 may include at least one of a speaker, a microphone, or a circuit for controlling them.

The camera module 212 collects data for generating images and videos. To this end, the camera module 212 may include at least one of a lens, a lens driving circuit, an image sensor, a flash, or an image processing circuit. The camera module 212 may collect light through the lens and generate data expressing color values and luminance values of light using the image sensor.

The memory 214 may store an operating system, programs, applications, commands, setting information and the like that are necessary to operate the client device. The memory 214 may temporarily or non-temporarily store data. The memory 214 may include a volatile memory, a non-volatile memory, or a combination of the volatile and non-volatile memory.

The power supply unit 216 supplies power necessary for the operation of components of the client device. To this end, the power supply unit 216 may include a converter circuit that converts power into power with a magnitude required by each component. The power supply unit 216 may depend on an external power source or may include a battery. In the case of including the battery, the power supply unit 216 may further include a circuit for charging. The circuit for charging may support wired charging or wireless charging.

The external connection terminal 218 is a physical connection unit for connecting the client device to another device. For example, the external connection terminal 218 may include at least one of terminals of various standards, such as a universal serial bus (USB) terminal, an audio terminal, a high definition multimedia interface (HDMI) terminal, a recommended standard-232 (RS-232) terminal, an infrared terminal, an optical terminal, or a power terminal.

The processor 220 controls the overall operation of the client device. The processor 220 may control operations of other components and perform various functions using other components. For example, the processor 220 may also request content data from the server through the communication unit 206 and receive the content data. Also, the processor 220 may restore content by decoding the received content data. Also, the processor 220 may output content received from the server through the display 202 and the audio input/output unit 210. In addition, the processor 220 may control a state related to reproduction of content based on information input or sensed by at least one of the input unit 204, the communication unit 206, the sensing unit 208, the audio input/output unit 210, the camera module 212, the power supply unit 216, and the external connection terminal 218. To this end, the processor 220 may include at least one of at least one processor, at least one microprocessor, or at least one digital signal processor (DSP). In particular, the processor 220 may control other components and perform necessary operations so that the client device operates according to various embodiments described below.

In the structure of the client device described with reference to FIG. 2, all components are illustrated as being connected to the processor 220. Although not shown in FIG. 2, at least some of the components may be connected through a bus. In this case, under the control of the processor 220, direct data exchange may be made between some components.

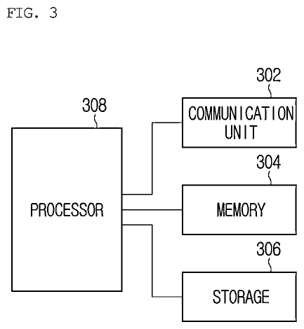

FIG. 3 illustrates a structure of a server according to an embodiment of the present disclosure. FIG. 3 exemplifies a block structure of a server (the server 120 of FIG. 1).

Referring to FIG. 3, the server includes a communication unit 302, a memory 304, a storage 306, and a processor 308. However, according to various embodiments, at least one of the components illustrated in FIG. 3 may be omitted.

The communication unit 302 provides an interface for communication of the server with another device. To this end, the communication unit 302 may include a circuit that generates and analyzes a physical signal for communication. The interface provided by the communication unit 302 may support wired communication or wireless communication.

The memory 304 may store various types of information, instructions and/or information and may load a computer program, an instruction, and the like stored in the storage 306. The memory 304 may temporarily store data and an instruction for an operation of the server and include a random access memory (RAM). Alternatively, the memory 304 may include various storage media.

The storage 306 may non-temporarily store an operation system for operating the server, a program for performing a function of the server, setting information for an operation of the server, and the like. For example, the storage 306 may include at least one of a non-volatile memory such as a read only memory (ROM), an erasable programmable ROM (EPROM), an electrically erasable programmable ROM (EEPROM), and a flash memory, a hard disk, a removable disc, a solid state drive (SSD), or any form of computer-readable recording medium widely known in the art to which the present disclosure belongs.

The processor 308 controls an overall operation of the server. The processor 308 may control operations of other components and perform various functions using other components. The processor 308 may include at least one of a central processing unit (CPU), a micro processor unit (MPU), a micro controller unit (MCU), or a well-known form of processor in the art to which the present disclosure belongs. Particularly, the processor 308 may control other components to enable the server to operate according to various embodiments described below and perform a necessary operation.

In a structure of a server described with reference to FIG. 3, components are exemplified to be all connected to the processor 308. Although not illustrated in FIG. 3, at least a part of the components may be connected through a bus. In this case, according to control of the processor 308, direct data exchange between some components may be made.

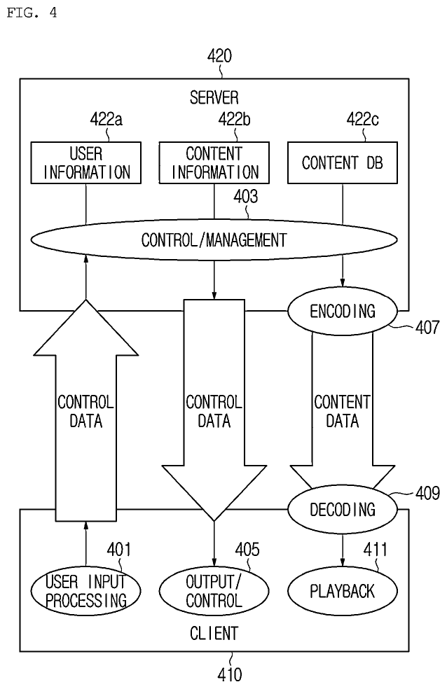

FIG. 4 illustrates a concept of a content streaming service according to an embodiment of the present disclosure. FIG. 4 is a schematic diagram of some functions related to content streaming, and a content streaming service according to various embodiments may have various other functions in addition to the functions illustrated in FIG. 4.

Referring to FIG. 4, control data and content data may be transmitted and received between the client 410 and the server 420. Specifically, transmission of control data from the client 410 to the server 420, transmission of control data from the server 420 to the client 410, and transmission of content data from the server 420 to the client 410 may be performed.

The server 420 stores user information 422a, content information 422b, and content database (DB) 422c. The user information 422a may include user account information, service use history information of users, information about user preferences, and the like. The content information 422b may include a list of serviceable content, content guide information, content meta information, and content consumption history information. The content DB 422c may include content stored in the form of data. In addition to this, the server 420 may further store other information required to provide services.

Control data transmitted from the client 410 to the server 420 may include information on user log-in, information on content selection by the user, information on control of content by the user, and the like. To this end, the client 410 may generate control data from user input through a user input processing operation 401 and transmit it. Control data from the client 410 is processed through a control/management operation 403 and used to provide content. For example, control data and/or content may be selected based on the control data from the client 401 by the control/management operation 403. In addition, preference may be determined by analyzing consumption history and behavior of the user by the control/management operation 403, and content to be recommended may be selected according to the determined preference.

A procedure for providing content to a user will be described with reference to FIG. 4 as follows. First, the client 410 generates control data including log-in information (e.g., ID and password) input by a user through the user input processing operation 401 and transmits the control data. The server 420 determines whether the user is valid by searching the user information 422a for log-in information included in the control data from the client 410, and determines the range of content and services allowed according to the user's authority. However, if log-in is not required or limited services that may be provided without log-in are supported, the transmission and processing of log-in information may be omitted.

Subsequently, the server 410 extracts content guide information from the content information 422b through the control/management operation 403 and transmits control data including the content guide information to the client 410. The client 410 outputs the content guide information included in the control data and confirms user's selection. The user's selection is transmitted to the server 410 as control data via the user input processing operation 401. Information about the user's selection is processed by the control/management operation 403 and used for selection of content to be streamed. The server 420 searches the content DB 422 for the selected content, compresses and segments the searched content through an encoding operation 407, and transmits content data. The content data may be compressed in advance through the encoding operation 407 and stored. Here, the encoding operation 407 may include not only an operation of compressing an original content image, but also an operation of decoding and then re-compressing content data generated through compression. In this case, compression may be performed based on the resolution, bitrate, and number of frames per second of the content image. When it is compressed and stored in advance, the compression operation may be omitted, and the server 420 may perform segmentation on the content data. The content data may be restored through a decoding operation 409 and provided to a user through a playback operation 411. At this time, at least one of various video codecs or various audio codecs may be used for compression. For example, various video codecs include at least one of Moving Picture Experts Group-2 (MPEG-2), H.264 Advanced Video Coding (AVC), H.265 High Efficiency Video Coding (HEVC), H.266 Versatile video coding (VVC), VP8 (Video Processor 8), VP9 (Video Processor 9), AV1 (AOMedia Video 1), Divx, Xvid, VC-1, or Daala.

The audio codecs may include MP3 (MPEG 1 Audio Layer 3), AC3 (Dolby Digital AC-3), E-AC3 (Enhanced AC-3), AAC (Advanced Audio Coding, MPEG 2 Audio), FLAC (Free Lossless Audio Codec), HE-AAC (High Efficiency Advanced Audio Coding), OGG Vorbis, OPUS and the like.

A plurality of content data may be generated in advance by compressing a content image according to various resolutions, bitrates, and the number of frames per second of the image. The client 410 may measure throughput (or bandwidth) and determine a bitrate based on the measured throughput (or bandwidth).

Throughout the specification, the term “image” or “content image” may be used to refer to still images, a series of still images, moving images, pictures and videos, and the like, that may be regenerated or displayed by a user terminal.

The client 410 may receive information about a plurality of content data from the server 420. The received information may include information representing the bitrate, resolution, number of frames per second, and location of a plurality of content data.

The client 410 may determine at least one of content data based on the bitrate, and determine reproduced content data corresponding to the resolution and number of frames per second that may be reproduced among the at least one content data based on the capability information of the client 410, and its location. In this case, the capability information may include the maximum support resolution and the maximum number of supported frames of the client, but is not limited thereto.

The client 410 may transmit a content request to the server 420 based on the location of reproduced content data. The server 420 may transmit content data corresponding to the content request to the client 410 based on the received content request.

According to another embodiment, the client 410 may receive user input related to at least one of the resolution or number of frames per second of the image, determine the reproduced content data and its location according to the user input, and transmit the content request to the server 420.

The present disclosure relates to a real-time scene analysis technique based on a request of a user. According to various embodiments of the present disclosure, a user may generate a bookmark while watching an image, share the generated bookmark with another user, and use a bookmark generated by another user. Herein, a bookmark may be data about a specific section (scene) present in an image. Specifically, a bookmark may be data about a start time and/or an end time of a specific section within an image. In addition, a bookmark may further include data indicating an image (for example, data about an address (location) such as URL). Herein, a start time and an end time may be indicated by using any one of a time value and a frame number, but the present disclosure is not limited thereto. In addition, according to various embodiments of the present disclosure, a representative scene may mean a scene that is already analyzed and stored in the server 120. A representative scene may be selected based on the number of scene saves by a plurality of users, the number of hits, feedback information (like, save, share, etc.) and the like, but the present disclosure is not limited thereto. In addition, according to various embodiments of the present disclosure, the server 120 may analyze a scene, store an analyzed scene, and also calculate a ranking of a scene stored in the server 120. Hereinafter, the present disclosure will describe various embodiments with reference to the drawings.

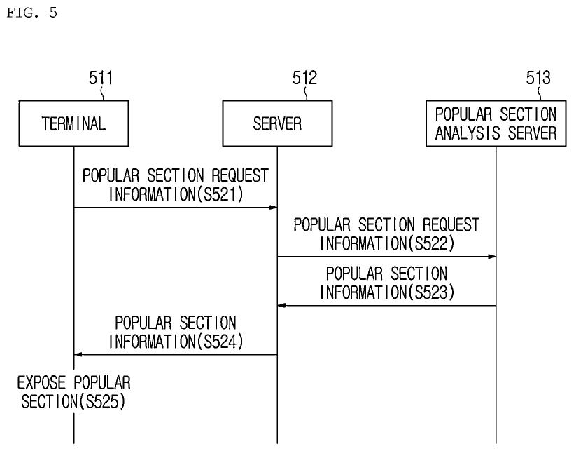

FIG. 5 illustrates a procedure of receiving popular section information according to an embodiment of the present disclosure. A server 512 of FIG. 5 may be understood as a server of a content streaming system (e.g., the server 120 of FIG. 1). In addition, a popular section analysis server 513 may also be understood as the same server of the content streaming system (e.g., the server 120 of FIG. 1) or be understood as a separate different server. In addition, a terminal 511 of FIG. 5 may be understood as a terminal of a content streaming system (e.g., the terminal 110 of FIG. 1).

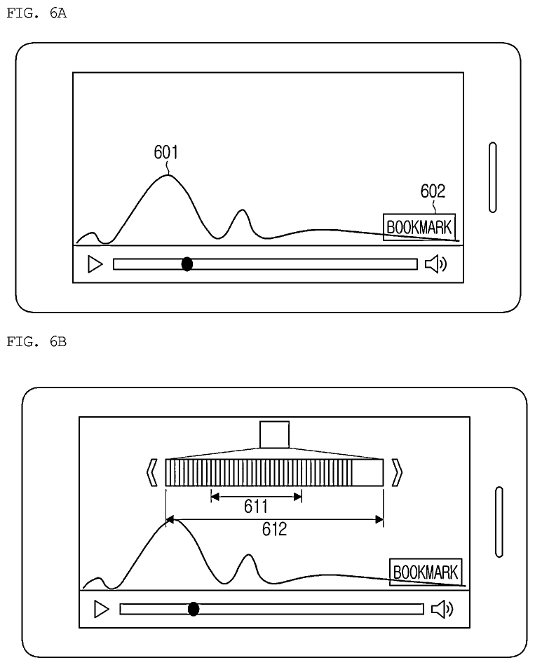

Referring to FIG. 5, in order to receive popular section information according to an embodiment of the present disclosure, the terminal 511 may request the popular section information. More specifically, at step S521, when a user requests a popular section for an image that the user is watching, the terminal 511 may transmit popular section request information to the server 512. Herein, the popular section may mean a scene with a high number of views and/or saves. Referring to FIG. 6A, a popular section may be represented by a graph 601 of the cumulative number of views per scene, a graph of the number of scene saves, or a graph 601 that reflects both the cumulative number of views and the number of scene saves, but the present disclosure is not limited thereto. In addition, in the present disclosure, “scene” may be understood in the same meaning as “section” or “image section”.

Next, at step S522, the server 512 may transmit the popular section request information to a popular section analysis server 513. After the popular section analysis server 513 receives the popular section request information, at step S523, the popular section analysis server 513 may perform a popular section analysis and transmit popular section information to the server 512. Herein, the popular section information may include data identifying a representative scene within the image. Specifically, the popular section information may include a start time and/or an end time of the representative scene. Herein, the start time and the end time may be expressed by using any one of a time value and a frame number. Next, at step S524, the server 512, which has received popular section information from the popular section analysis server 513, may transmit the popular section information to the terminal 511. Next, at step S525, the terminal 511, which has received the popular section information from the server 512, may display a popular section based on the received popular section information.

According to an embodiment of the present disclosure, the server 512 of FIG. 5 and the popular section analysis server 513 may be the same server. In this case, the popular section analysis server 513 may receive popular section request information directly from the terminal 511. In addition, the popular section analysis server 513 may transmit popular section information directly to the terminal 511.

FIG. 6A illustrates popular section information according to an embodiment of the present disclosure. A terminal may display information on a popular section as a graph 601 of the cumulative number of views, a graph 601 of the number of scene saves, or a graph 601 that reflects both the cumulative number of views and the number of scene saves. This display may be provided either automatically or in response to a user request. By viewing the displayed graph 601, the user may select and view a corresponding popular section. Herein, the graph 601 of the cumulative number of views, the graph 601 of the number of saves, or the graph 601 that reflects both the cumulative number of views and the number of scene saves may indicates sections that many users using the server 120 have watched and/or saved. A graph according to the present disclosure may be a connected graph but is not limited thereto and may be expressed in other forms, such as a bar graph, a line graph, or other graphical types.

FIG. 6B illustrates a modification screen of an analyzed scene according to an embodiment of the present disclosure. Referring to FIG. 6B, a terminal may display information on a popular section as the graph 601. When the user clicks on a specific point or part (i.e., the selected point or part) on the graph 601 that the user desires to store, the terminal may display a selected scene corresponding to the selected point or part. Herein, the selected scene corresponding to the selected point or part may be a scene previously analyzed by the popular section analysis server 513. The selected scene may be presented as a sequence of frames.

Specifically, the terminal may display frames 611 (hereinafter, first scene frames) constituting the selected scene. In addition, the terminal may also display frames that precede and follow the first scene frames 611. These surrounding frames, together with the first scene frames 611 may be referred to as the second scene frames 612, and the second scene frame 612 encompasses the first scene frames 611.

Here, the user may modify the first scene frames 611 of the selected scene. For example, the user may store the selected scene by including some preceding and/or subsequent frames from the second scene frames or by removing certain frames from the first scene frames 611. Such modification may be performed by adjusting the start time and/or end time of the selected scene.

The start time and/or end time of the selected scene may be modified by a user input. For example, when a boundary of the selection scene is dragged via a mouse cursor or a touch input on a display of the terminal, the corresponding start time and/or end time may be modified. However, the present disclosure is not limited to this specific method of modification.

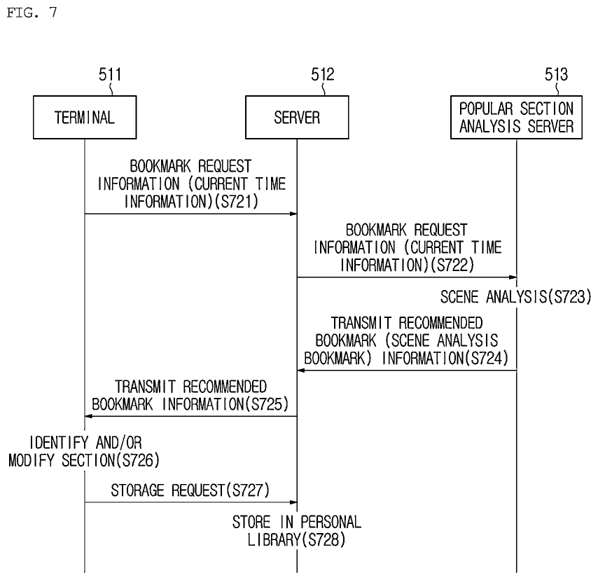

FIG. 7 illustrates a scene analysis procedure based on a bookmark generation request according to an embodiment of the present disclosure. The server 512 of FIG. 7 may be understood as a server of a content streaming system (e.g., the server 120 of FIG. 1). In addition, the popular section analysis server 513 may also be understood as the same server of the content streaming system (e.g., the server 120 of FIG. 1) or be understood as a separate different server.

Referring to FIG. 7, at step S721, the terminal 511 may transmit bookmark request information (e.g., current time information on the image) to the server 512. The bookmark request information may be generated by a user's clicking on a bookmark button 602 displayed on a display of the terminal 511. Bookmark request information may include the current time information of the image that the user is watching and/or information indicating a location of an image that the user is watching.

Next, at step S722, the server 512 may transmit bookmark request information to the popular section analysis server 513. At step S723, the popular section analysis server 513, which has received the bookmark request information from the server 512, may perform scene analysis. That is, the popular section analysis server 513 may perform scene analysis by using the current time information included in the bookmark request information.

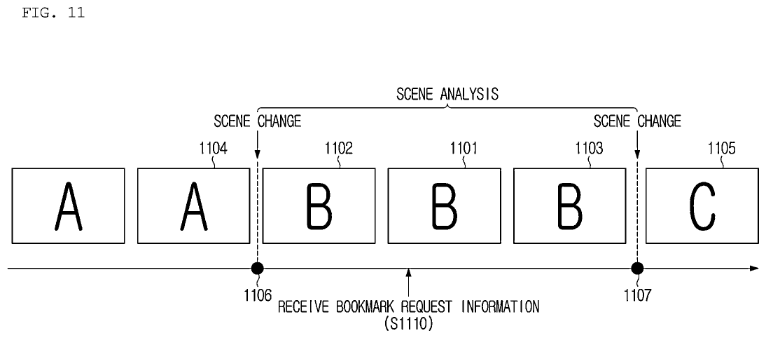

Here, the scene analysis may be performed to extract a bookmark scene by using the bookmark request information and to store the bookmark scene in a scene library. That is, as an operation performed to store a bookmark scene that a user wants, scene analysis may include an operation (e.g., frame analysis, analysis of relationship between frames, etc.) for extracting a scene from a corresponding image content based on the current time information in bookmark request information. According to an embodiment, scene analysis may be performed by using a degree of similarity between frames on the basis of a frame corresponding to the current time information in the bookmark request information. In addition, according to another embodiment of the present disclosure, scene analysis may be performed by using a trained artificial intelligence (AI) model, but the present disclosure is not limited thereto. A further detailed scene analysis method will be described through FIG. 11.

At step S724, the popular section analysis server 513, which has completed scene analysis, may transmit recommended bookmark information to the server 512. The recommended bookmark information may include information on a start time and/or an end time of the extracted bookmark scene. For example, the recommended bookmark information may include information on 1) a start time of the bookmark scene or an end time of the bookmark scene and 2) a period (difference between a start time and an end time of the bookmark scene). Herein, the start time and the end time may be indicated by using any one of a time value and a frame number. In addition, the recommendation bookmark information may include the image frames of the extracted bookmark scene. At step S725, the server 512, which has received the recommended bookmark information, may transmit the recommended bookmark information to the terminal 511.

At step S726, the terminal 511, which has received the recommended bookmark information, may confirm and/or modify a recommended bookmark scene. Specifically, the terminal 511 may confirm the recommended bookmark information and then request the server 512 to store the information. In this case, at step S728, the server 512 may store the bookmark information in a personal library according to a storage request of the terminal 511. When the sever 512 stores the bookmark information, image data (i.e., the image frames) of the recommended bookmark scene may be stored. Alternatively, instead of the image data about the bookmark scene, only information on a start time and/or an end time of the bookmark scene may be stored in a personal library. In this case, since only information on a time is stored, the storage space of the server 512 may be efficiently used.

According to another embodiment of the present disclosure, the terminal 511, upon receiving recommended bookmark information, may modify the recommended bookmark scene according to the recommended bookmark information. For example, the terminal 511 may perform modification to change a start time and/or an end time of the recommended bookmark scene according to recommended bookmark information. Such change of the start time and/or the end time of the section for bookmark may be performed by a user input on the display of the terminal. For example, when a boundary of the recommended bookmark scene is dragged via a mouse cursor or a touch input on a display of the terminal, the corresponding start time and/or end time may be modified. However, the present disclosure is not limited to this specific method of modification. Then, the terminal 511 may request the server 512 to store the modified bookmark scene.

The server 512, which receives a storage request, may store the modified bookmark scene information in a person library in response to the storage request (S728). When stored, image data (i.e., image frames) of the bookmark section may be stored. Alternatively, instead of the image data of the bookmark section, only information on a start time and/or an end time of the bookmark section may be stored in a personal library. In this case, since only information on a time is stored, the storage space of the server 512 may be efficiently used.

According to yet another embodiment of the present disclosure, after performing scene analysis (S723), the popular section analysis server 513 may immediately store the recommended bookmark information in a personal library, without transmitting recommended bookmark information (scene analysis bookmark information) to the server 512.

According to another embodiment of the present disclosure, the server 512 and the popular section analysis server 513 of FIG. 7 may be the same server. In this case, the popular section analysis server 513 may receive bookmark request information directly from the terminal 511. In addition, the popular section analysis server 513 may transmit recommended bookmark information directly to the terminal 511.

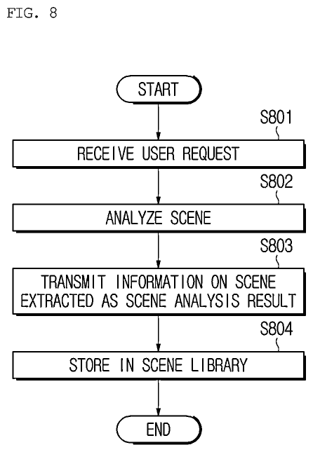

FIG. 8 illustrates a flowchart of a scene analysis method according to an embodiment of the present disclosure. A scene analysis procedure of FIG. 8 may be performed by a server of a content streaming system (e.g., the server 120 of FIG. 1).

Referring to FIG. 8, at step S801, the server 120 may receive a user request. Herein, the user request may be a bookmark generation request. Specifically, when a user requests to generate a bookmark at a specific time (e.g., current time) of an image that the user is currently watching, the server 120 may receive, from the terminal, bookmark request information including information corresponding to the specific time (i.e., the bookmark basis time).

At step S802, the server 120 may perform scene analysis. Herein, the scene analysis may be performed by using a degree of similarity between frames. Herein, the degree of similarity between frames may be determined based on a degree of similarity of pixels present in frames. In addition, according to another embodiment of the present disclosure, the scene analysis may be performed by using a trained artificial intelligence (AI) algorithm. For example, scene analysis may be performed by a scale invariant feature transform (SIFT) algorithm.

The SIFT is an algorithm for extracting invariant feature points and descriptors according to the size and rotation of an image, and a degree of similarity between frames may be determined through descriptor comparison of SIFT feature points. In addition, as an alternative to the SIFT algorithm, a speed up robust features (SURF) algorithm may be used. Alternatively, as an alternative to the SIFT algorithm, an oriented and rotated binary robust independent elementary features (ORB) algorithm may be used. Alternatively, as an alternative to the SIFT algorithm, a features from accelerated segment test (FAST) algorithm may be used. Alternatively, a first algorithm for extracting a feature point and a second algorithm for extracting a descriptor may be used. Herein, the first algorithm and the second algorithm may be one of the above-described algorithms but are not limited thereto. The first algorithm and the second algorithm may be different.

As another example, the server may extract a feature point by using a feature point extraction deep neural network (DNN), generate a multi-dimensional (e.g., 128 dimensions) descriptor for the extracted feature point (by using the above-described algorithms), extract a matching point between frames through descriptor comparison, and when a ratio of matching point is equal to or below a predetermined threshold, detect a scene change. Herein, the DNN may be a neural network that has a part of frame as input data and a probability of a feature point as output data.

According to an embodiment, the server 120 may determine frames for the bookmark scene using the similarity analysis based on the bookmark basis time and/or a bookmark basis frame corresponding to the bookmark basis time. Specifically, the server 120 may set a start frame or a start time of the bookmark scene when the frames between the start time and the bookmark basis time have a similarity with the bookmark basis frame higher than a predetermined threshold. Similarly, the server 120 may set an end frame or an end time of the bookmark scene when the frames between the bookmark basis time and the end time have a similarity with the bookmark basis frame higher than a predetermined threshold.

As a result of scene analysis according to the present disclosure, a scene constructed by a set of some continuous frames in an image may be extracted. A further detailed scene analysis method will be described through FIG. 11.

At step S803, the server 120 may transmit scene information extracted as a scene analysis result. Herein, the scene information may include information on a specific scene in an image (i.e., the bookmark scene) analyzed by the server 120. Specifically, the scene information may include information on a start time and/or an end time of a specific scene present in an image. In the present disclosure, “scene information” may be understood in the same meaning as “recommended bookmark information” or “scene analysis bookmark information”.

At step S804, the server 120 may store an extracted scene in a scene library. Specifically, the server 120 may store a scene extracted at step S802 in a scene library. Once storing the analyzed scenes in a scene library, the server 120 may collect information on a user's taste, preference and the like based on the stored analyzed scenes (e.g., the categories, types, genres, etc.). Accordingly, the server 120 may recommend an image suitable for the user's preference. Herein, an extracted scene may be stored in a scene library irrespective of a user's storage request. That is, when the server 120 completes scene analysis, the server 120 may immediately store an analyzed scene in a scene library. In this case, the user may modify the analyzed scene later, and the present disclosure is not limited thereto.

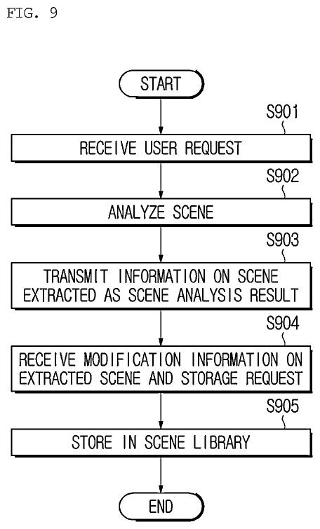

FIG. 9 illustrates a flowchart of a scene analysis method according to an embodiment of the present disclosure. A scene analysis procedure of FIG. 9 may be performed by a server of a content streaming system (e.g., the server 120 of FIG. 1).

Referring to FIG. 9, at step S901, the server 120 may receive a user request. Herein, the user request may be a bookmark generation request. Specifically, when a user requests to generate a bookmark at a specific time of an image that the user is currently watching, the server 120 may receive, from the terminal, bookmark request information including information corresponding to the specific time (i.e., the bookmark basis time).

At step S902, the server 120 may perform scene analysis. Herein, the scene analysis may be performed by using a degree of similarity between frames. In addition, according to another embodiment of the present disclosure, scene analysis may be performed by using a trained artificial intelligence (AI) model, but the present disclosure is not limited thereto. The scene analysis may be performed in the same processes described above in reference to FIG. 8.

As a result of scene analysis according to the present disclosure, a scene constructed by a set of some continuous frames in an image may be extracted. A further detailed scene analysis method will be described through FIG. 11.

At step S903, the server 120 may transmit scene information extracted as a scene analysis result. Herein, the scene information may include information on a specific scene in an image (i.e., the book scene) analyzed by the server 120. Specifically, the scene information may include information on a start time and/or an end time of a specific scene present in an image. In the present disclosure, “scene information” may be understood in the same meaning as “recommended bookmark information” or “scene analysis bookmark information”.

At step S904, the server 120 may receive a storage request for the extracted scene. Specifically, the server 120 may receive, from the terminal, information regarding whether or not to store the scene extracted at step S902. At this time, the user may modify the extracted scene and then request to store the scene. For example, the user may modify a start time and/or an end time of the extracted scene.

At step S905, the server 120 may store the extracted scene in a scene library. Specifically, the server 120 may store the scene extracted at step S902 in a scene library according to the user's storage request. Once storing the extracted scene in the scene library according to the user's storage request, the server 120 may collect information on the user's taste, preference and the like based on the stored analyzed scenes (e.g., the categories, types, genres, etc.). Accordingly, the server 120 may recommend an image suitable for the user's preference.

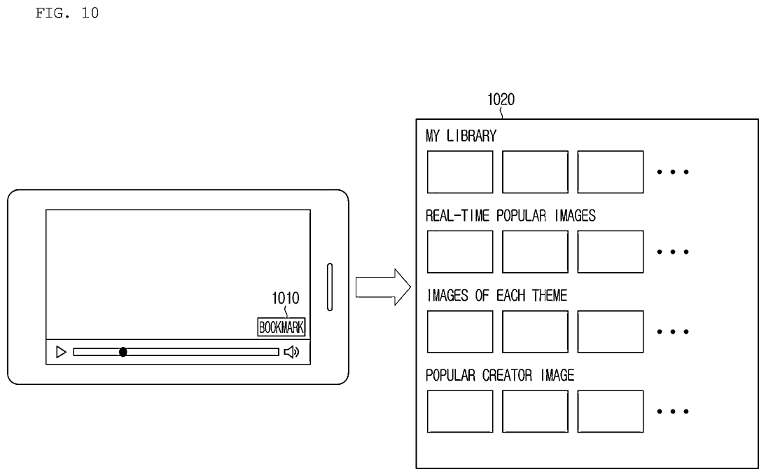

FIG. 10 illustrates an example of storing in a scene library according to an embodiment of the present disclosure. Specifically, a user may click on a bookmark button 1010 shown on a display of an image player at a specific time where the user wants to store while watching an image. Accordingly, the server 120 may analyze a scene by using information on the time of the image being played (hereinafter, first time) where the user clicks on the bookmark button 1010. The server 120 may store a scene extracted as an image analysis result in a scene library 1020 regardless of the user's storage request. According to another embodiment of the present disclosure, the server 120 may store a scene extracted as an image analysis result in the scene library 1020 according to a user's storage request.

A scene stored for each user may be classified according to each theme (based on a theme label) to be displayed or may be displayed according to each title. A user may assign a score to each scene stored in a library, and thus scenes may be displayed in order of score. However, the present disclosure is not limited thereto, but scenes may be displayed in order of hits. In addition, when a user selects a theme, scenes included under the same theme may be successively played. Each scene may be stored in a terminal in an image file format (e.g., GIF) according to a user's request.

The scene library 1020 may include not only images stored for each user (“my library”) but also “real-time popular images” and the like. Real-time popular images and the like may be displayed in the scene library 1020 based on ranking using user's feedback. In addition, the scene library 1020 may include “scenes of each theme”. Images of each theme may be displayed in the scene library 1020 according to ranking based on users' tastes, preferences and the like (e.g., theme labels of images that users store in the library). Herein, a preview scene displayed in “real-time popular images” and “images of each theme” may be one representative scene determined in consideration of various elements. When a user selects the representative scene, scenes similar to the scene (that is, scenes of different sections within a same image) may be displayed according to ranking, but the present disclosure is not limited thereto, and only the representative scene may be displayed.

The scene library 1020 may include an image of each popular creator (“popular creator image”). A scene displayed in a “popular creator image” may be determined based on a total number of hits/feedbacks in a scene library, interest in a corresponding creator (number of followers), or the like.

A preview image provided in the scene library 1020 may be dynamically composed only of I-frames within a start time and an end time.

When a scene stored in the scene library 1020 is played, an indicator indicating the start time and end time of the scene may be displayed, and an indicator indicating a section outside the scene may be displayed together. When a section outside a scene is selected, a user may watch an image of the section outside the scene. At this time, a watch range may be automatically changed to a whole image range. According to another embodiment, when a user watches a corresponding image, a scene part stored in the user's own library may be separately displayed by an indicator.

Scenes of the scene library 1020 may be retrieved by using a search function. In this case, scenes may be retrieved based on a degree of similarity between a keyword and metadata of a scene, and the metadata of a scene may be determined beforehand based on a theme label given to the scene. FIG. 11 illustrates an example of real-time scene analysis according to an embodiment of the present disclosure. Scene analysis of FIG. 11 may be performed by a server of a content streaming system (e.g., the server 120 of FIG. 1).

Referring to FIG. 11, the server 120 may receive bookmark request information (S1110). Herein, the bookmark request information may be generated by a user's click on a bookmark button. The bookmark request information may include information on a first time point. After receiving the bookmark request information, the server 120 may identify a basis frame 1101 of the first time point and frames 1102 and 1103 before/after the first time point (i.e., frames immediately preceding/following the first frame) (hereinafter, first frames) by using information in the bookmark request information. Next, the server 120 may compare each of the frames 1101, 1102 and 1103. Comparison of each of the frames 1101, 1102 and 1103 may be made based on a degree of similarity between frames. Herein, a degree of similarity between frames may be determined based on pixels of each frame or a degree of similarity of pixel groups. Herein, a pixel group may include a plurality of pixels, and for example, a pixel group may be a K×K block (K is an integer greater than 1).

When a degree of similarity, which is a comparison result of similarity between the basis frame 1101 and the first frames 1102, 1103, is greater than a predetermined threshold, each of the frames 1101, 1102 and 1103 may be determined to be similar frames to each other. In this case, the server 120 may identify second frames 1104 and 1105 adjacent to the first frames 1102, 1103. After identifying the second frames, the server 120 may compare the basis frame 1101 and the second frames 1104, 1105. When a degree of similarity, which is a comparison result of similarity between the frame 1101 and the second frames 1104, 1105, is below a predetermined threshold, each of the frames 1101, 1104 and 1105 may be determined to be dissimilar frames to each other. Herein, the server 120 may determine that a scene is changed based on a time point that is determined as a dissimilar frame, and store information indicating scene change time points 1106 and 1107 (or frames immediately before/after the time points 1106 and 1007) as bookmark information. According to the present disclosure, determination of scene change time point before the first time point and determination of scene change time point after the first time point may be independently performed, but the present disclosure is not limited thereto. In addition, according to the present disclosure, scene analysis may be performed automatically in real time. In addition, the server 120 may arbitrarily determine a predetermined threshold or may have certain value as a predetermined threshold according to the present disclosure, but the present disclosure is not limited thereto.

According to another embodiment of the present disclosure, the server 120 may perform scene analysis by using a popular section. Specifically, the server 120 may perform scene analysis based on a peak point by using a popular section 601 expressed by a graph. Herein, as an example, scene analysis using a peak point may use a predetermined equation, but the present disclosure is not limited thereto.

According to another embodiment of the present disclosure, the server 120 may perform scene analysis based on a predetermined time duration before and after a bookmark time point (i.e., the first time point). That is, according to an embodiment, the server 120 may define a bookmark scene using a time duration either determined by a user or predetermines by the server 120. For example, the server 120 may define a bookmark scene as comprising a duration of R seconds before and R seconds after the first time point. Here, R may be a positive real number. Scene analysis based on a predetermined time duration may be performed when scene analysis according to other embodiments of the present disclosure is not performed or cannot be performed. For example, the scene analysis based on a predetermined time duration may be performed last, when scene analysis according to other embodiments of the present disclosure fail or are not feasible.

According to another embodiment of the present disclosure, scene analysis may be performed by using a trained artificial intelligence (AI) model. That is, the server 120 may detect a scene change time point by using an AI model trained to identify such transition.

For example, an AI model may be trained by using images and corresponding scene change time point information. In particular, the training data may include a set of images and associated information indicating scene change time points within the those images. Such AI model for scene change analysis may be referred to as a first scene change analysis AI model. By using the first algorithm (i.e., the first scene change analysis AI model), the server 120 may perform accurate scene analysis. Herein, the information indicating a scene change time may be indicated by using any one of a time value and a frame number.

Meanwhile, training of an AI model for scene change analysis may be performed through theme labels given to each image frames. That is, the server 120 may recognize a scene theme at each frame within an image and detect a scene change time. Herein, the theme label may be a classification label regarding a specific actor, a specific action (fight, kiss, performance, etc.), a specific original soundtrack (OST), a specific background music (BGM), a specific place and the like, but the present disclosure is not limited thereto. According to the present disclosure, the AI model may be trained by using a theme label given to each frame. When using this algorithm, the server 120 may give a theme label according to each frame of an image and analyze a scene by using the given theme label. For example, when a frame of a first time point (i.e., a bookmark basis time point) corresponds to a specific theme, the server 120 may give a theme label to the frame. Then, the server 120 may determine theme labels of frames before and after the first time point. Accordingly, when it is determined, while identifying a theme label according to each frame, that a theme label changes at a specific frame, the server 120 may determine a corresponding time as a scene change time and analyze a scene accordingly. Also, for example, the AI model may be trained using training data that includes frames having scene theme labels that are assigned to the frames and associated information indicating scene change time points. Using this training, the AI model may be trained to identify scene change time points when given a specific first time point (i.e., a bookmark basis time point) in an image having frames with labels. The aforementioned algorithm or AI model may be referred to as the second algorithm or the scene change analysis AI model.

According to an embodiment of the present disclosure, the server 120 may perform scene analysis by using audio data. For more accurate scene analysis, the server 120 may determine a scene change time by using audio data of a corresponding scene and perform scene analysis. Specifically, the server 120 may determine a time, where audio data played at the first time is disconnected or changed, as a scene change time.

According to another embodiment of the present disclosure, the server 120 may perform scene analysis by using a specific actor, a specific action (fight, kiss, performance, etc.), a specific original soundtrack (OST), and the like. For more accurate scene analysis, the server 120 may determine a scene change time by the AI model recognizing a time where a specific actor shows or a time where a specific action or a specific OST is played, and perform scene analysis accordingly.

According to an embodiment of the present disclosure, the server 120 may use either the first scene change analysis AI model or the second scene change analysis AI model when the other fails. The server 120 may use one of the two before the other according to a predetermined order. The order of using the first and second scene change analysis AI models may be changed.

According to an embodiment of the present disclosure, when scene analysis using the first algorithm fails due to an error, the server 120 may use the second algorithm, and an order of using algorithms may be changed. Herein, the error may mean a case where the server 120 determines a time as a scene change time although the time is not a scene change time, but the present disclosure is not limited thereto.

In addition, the server 120 may first attempt to utilize the scene analysis according to a degree of similarity between frames in FIG. 11. When such scene analysis according to a degree of similarity fails, the server 120 may use at least one of the first algorithm, the second algorithm, audio data, a specific actor, a specific action, and a specific OST. The scene analysis method according to the present disclosure is not limited thereto.

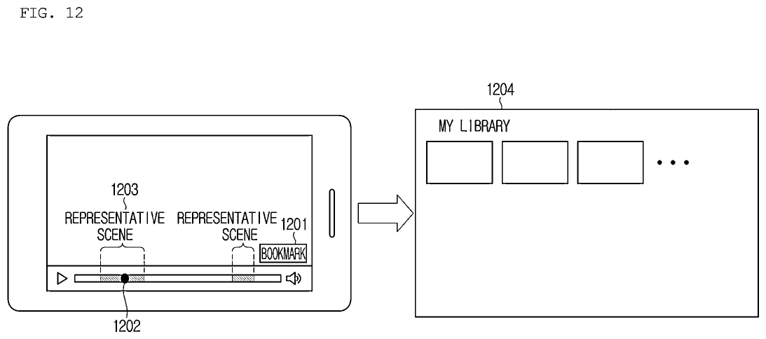

FIG. 12 illustrates a method for storing a previously extracted scene according to an embodiment of the present disclosure. Storage of a previously analyzed scene of FIG. 12 may be performed by a server of a content streaming system (e.g., the server 120 of FIG. 1).

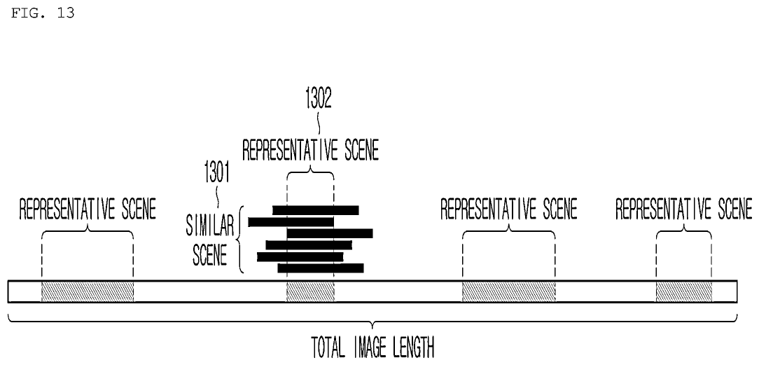

Referring to FIG. 12, a user may click on a bookmark button 1201 shown on a display of an image player (e.g., terminal) at a specific time point where the user wants to store while watching an image. Herein, the server 120 may identify information 1202 on a time point of pressing the bookmark button (hereinafter, second time point). When the second time point is included in a representative scene 1203 which has been previously analyzed by the server 120, the server 120 may store the representative scene in a scene library 1204 without scene analysis. Herein, the representative scene may mean a scene that is previously analyzed and stored in the server 120. A representative scene may be selected based on the number of scene saves by a plurality of users, the number of hits, feedback information (like, save, share, etc.) and the like, but the present disclosure is not limited thereto. A further detailed method of extracting a representative scene will be described below with reference to FIG. 13.

FIG. 13 illustrates an example of extracting a representative scene according to an embodiment of the present disclosure. Extraction of a representative scene of FIG. 13 may be performed by a server of a content streaming system (e.g., the server 120 of FIG. 1).

Referring to FIG. 13, the server 120 may identify scenes that users store through bookmark generation requests in a single image. Herein, the scenes that users store through bookmark generation requests may be referred to as similar scenes. Herein, when similar scenes 1301 are concentrated at a specific time, the server 120 may select and extract a representative scene 1302 at the time. Herein, to select the representative scene 1302, the server 120 may use the number of overlapping similar scenes. That is, the server 120 may select a corresponding scene as a representative scene, when the number of overlapping similar scenes at a specific time is equal to or greater than a predetermined threshold.

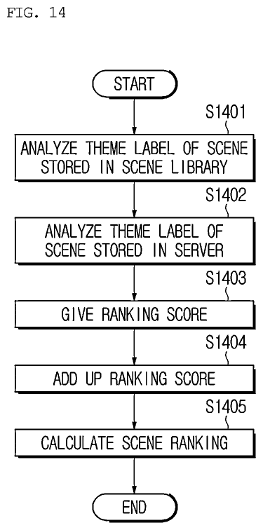

FIG. 14 illustrates a flowchart of ranking a scene according to an embodiment of the present disclosure. The scene ranking method of FIG. 14 may be performed by a server of a content streaming system (e.g., the server 120 of FIG. 1).

Referring to FIG. 14, at step S1401, the server 120 may analyze a theme label (hereinafter, first theme label) of a scene stored in a scene library of a particular user. Herein, the scene stored in the scene library may be a scene stored through scene analysis as a result of the particular user's bookmark generation request. Accordingly, the server 120 may recommend, to the particular user, a scene of similar type to the scene stored in the scene library of the particular user and rank the scenes.

At step S1402, the server 120 may analyze a theme label (hereinafter, second theme label) of a scene stored in the server 120 by other users. Herein, the scene stored in the server 120 may be a scene stored by other users using the content streaming system according to the present disclosure, but the present disclosure is not limited thereto.

At step S1403, the server 120 may give a ranking score. Specifically, the server 120 may identify the first theme label and the second theme label. Next, the server 120 may compare the first theme label and the second theme label analyzed at steps S1401 and S1402. When the first theme label and the second theme label are the same, the server 120 may give a ranking score to a corresponding scene. A single scene may have a plurality of theme labels, and the more theme labels overlap with a scene stored in the particular user's scene library, the higher ranking score may be given to the scene. For example, when a same actor appears in a scene being compared and a scene stored in the particular user's scene library, the server 120 may give a ranking score of 1 to the scene. In addition, when a same BGM is used in a corresponding scene, the server 120 may give a ranking score of 1 to the scene. Herein, the ranking score given may vary depending on the theme, and the present disclosure is not limited thereto. In addition, ranking scores may be given based on whether or not theme labels are similar, not based on whether or not theme labels are the same. In this case, ranking scores may be given based on weights corresponding to degrees of similarity of theme labels.

At step S1404, the server 120 may add up ranking scores. Specifically, ranking scores given to a specific scene at step S1403 may be added up. For example, when a specific scene stored in the server 120 and a scene stored in the particular user's scene library have 3 identical theme labels, the server 120 may derive a ranking score of 3 by adding up ranking scores given to the specific scene. Herein, a ranking score may vary according to each theme label, and the present disclosure is not limited thereto.

At step S1405, the server 120 may calculate a scene ranking. Specifically, a scene ranking may be calculated by using a ranking score added up at step S1404. The server 120 may calculate a scene ranking by comparing ranking scores given to respective scenes. The higher the ranking score, the higher ranking may be given to a corresponding scene. Accordingly, the server 120 may display scenes in the particular user's scene library in order of ranking by using a ranking calculation result. Through such ranking calculation, the server 120 may calculate rankings of scenes according to each user's taste.

According to another embodiment of the present disclosure, the server 120 may calculate a ranking by using user's feedback in real time. Herein, users' feedback means the number of stored scenes, the number of likes, the number of saves, the number of hits, the number of shared scenes, and the like. Specifically, the server 120 may calculate rankings of all the scenes stored in the server 120 by using users' feedback and display the scenes in a scene library in order of rankings thus calculated. For example, a weight may be given to each piece of feedback, a ranking score of a scene may be calculated through a weighted sum, and a ranking may be calculated based on the calculated ranking score.

According to another embodiment of the present disclosure, the server 120 may calculate a ranking according to each theme of a scene. Specifically, the server 120 may classify themes by using an AI model and then calculate a ranking of each theme. Herein, rankings may be calculated by giving a ranking score based on a theme label and/or by using user's feedback, and the present disclosure is not limited thereto.

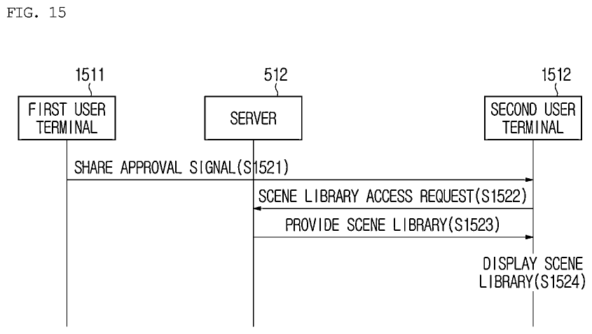

FIG. 15 illustrates a procedure of sharing a scene library according to an embodiment of the present disclosure. The server 512 of FIG. 15 may be understood as a server of a content streaming system (e.g., the server 120 of FIG. 1). In addition, a first user terminal and a second user terminal may be understood as a client device of a content streaming system (e.g., the client device 110 of FIG. 1).

Referring to FIG. 15, at step S1521, a first user terminal 1511 may transmit a share approval signal to a second user terminal 1512. Herein, the share approval signal may mean a signal including the intention that the second user terminal 1512 is approved to view a scene stored in a scene library of the first user terminal 1511. Accordingly, the second user terminal 1512, which has received the share approval signal, may request access to the scene library of the first user terminal to the server 512 (S1522). According to an embodiment, the request for access to the scene library from the second user terminal 1512 may include an indication of share approval from the first user terminal 1521. In response to the request for access to the scene library from the second user terminal 1512, the server 512 may provide the scene library of the first user terminal 1511 to the second user terminal 1512 (S1523). Herein, the scene library provided by the server 512 may be a scene library stored for the first user terminal 1511. The second user terminal 1512, upon receiving the scene library from the server 512, may display the received scene library to enable a user to select and watch it (S1524). Through such a process, users may share scene libraries with each other. Herein, a user authentication procedure of the server may be performed, and only an authenticated user may share a scene library, but the present disclosure is not limited thereto.

According to another embodiment of the present disclosure, the first user terminal 1511 may transmit a share approval signal to the server 512, and the server 512 may send the share approval signal to the second user terminal 1512.

The exemplary methods of the present disclosure are represented in a series of operations for clarity of description, but this is not intended to limit the order in which the steps are performed, and each step may be performed simultaneously or in a different order, if necessary. In order to realize a method according to the present disclosure, the steps illustrated may include further other steps, or may include the remaining steps with the exception of some steps, or may include additional other steps with the exception of some steps.

Various embodiments of the present disclosure are not intended to enumerate all possible combinations, but to describe a representative aspect of the present disclosure, and the matters described in the various embodiments may be applied independently or in combination of two or more. Also, it is noted that any one feature of an embodiment of the present disclosure described in the specification may be applied to another embodiment of the present disclosure. Similarly, the present invention encompasses any embodiment that combines features of one embodiment and features of another embodiment.

In addition, various embodiments of the present disclosure may be realized by hardware, firmware, software, or a combination thereof. In the case of hardware realization, the embodiments may be realized by one or more ASICs (Application Specific Integrated Circuits), DSPs (Digital Signal Processors), DSPDs (Digital Signal Processing Digital Signal Processing Devices (DSPs), Programmable Logic Devices (PLDs), Field Programmable Gate Arrays (FPGAs), general processors, controllers, microcontrollers, microprocessors, etc.

The scope of the present disclosure includes software or machine-executable commands (e.g., operating systems, applications, firmware, programs, etc.) that allow an operation according to a method of various embodiments to be performed on a device or computer, and a non-transitory computer-readable medium in which such software or commands are stored and executed on the device or computer.

1. A method for analyzing a scene in a content streaming system, the method comprising:
receiving a request for generating a bookmark scene in a content image;
analyzing a target scene in the content image by image processing based on the request to generate the bookmark scene; and
storing the generated bookmark scene in a scene library.

2. The method of claim 1, wherein the analyzing of the target scene comprises determining a change time point of scene change in the target scene, and
wherein the change time point in the target scene is determined based on a degree of similarity between frames of the target scene.

3. The method of claim 2, wherein the degree of similarity between the frames is determined further based on a degree of similarity of pixels or pixel groups between the frames.

4. The method of claim 1, wherein the analyzing of the target scene further comprises analyzing the target scene by using a trained artificial intelligence (AI) model, and
wherein the AI model is trained by using at least one of a set of training images and associated time point information of scene change within the training images.

5. The method of claim 4, wherein the AI model is trained by using at least one theme label corresponding to each frame.

6. The method of claim 4, wherein, when a first frame with a first theme label changes in order of playback time to a second frame with a second theme label, the second frame with the second theme label is determined as a frame of a scene change time.

7. The method of claim 5, wherein the theme label is given based on at least one of audio data, a specific actor, a specific action, a specific original soundtrack (OST), a specific background music (BGM), or a specific place.

8. The method of claim 5 further comprising:
analyzing a first theme label of an in-library scene stored in the scene library;
analyzing a second theme label of in-server scenes stored in a server;
giving a ranking score to a ranking scene from among the in-server scenes stored in the server by comparing the first theme label and the second theme label;
adding up the ranking score given to the ranking scene from among the in-server scenes stored in the server; and
displaying the ranking scene from among the in-server scenes stored in the server in descending order of the added-up ranking score.

9. The method of claim 1, further comprising:
receiving a request for identifying a popular section in the content image from a terminal; and
transmitting popular section information based on the request for identifying the popular section to the terminal,
wherein the request for generating the bookmark scene is generated based on the popular section information, and
wherein the popular section information is information on a popular section determined based on at least one of a number of accumulated scene views and a number of scene saves in the content image.

10. The method of claim 1, further comprising:
determining at least one representative scene based on a number of scene saves, a number of scene hits, or scene feedback information;
when the target scene is not analyzed based on the request for generating the bookmark scene, identifying a representative scene corresponding to the request for generating the bookmark scene; and
storing the identified representative scene in the scene library.

11. The method of claim 10, wherein the determining of the at least one representative scene comprises, when a number of overlapping similar scenes among similar scenes stored through the request for generating the bookmark scene is equal to or greater than a predetermined threshold, determining the representative scene as the overlapping similar scenes.

12. The method of claim 1, wherein the storing of the generated bookmark scene in the scene library comprises:
transmitting information on the generated bookmark scene to a terminal;
receiving a storage request based on a user input indicating modification of the generated bookmark scene from the terminal; and
storing a modified bookmark scene based on the storage request in the scene library, and
wherein the storage request includes information indicating at least one of a modified start time point and a modified end time point of the generated bookmark scene.

13. The method of claim 1, further comprising:
receiving a scene library access request from a second user terminal, after the second user terminal receives a share approval signal from a first user terminal; and
transmitting information on the scene library associated with a user of the first user terminal to the second user terminal according to the scene library access request.

14. A method for storing a scene in a content streaming system, the method comprising:
transmitting a request for generating a bookmark scene in a content image to a server;
receiving information on a scene analyzed based on the request from the server; and
based on the information on the scene, transmitting a request for storing the scene in a scene library to the server.

15. The method of claim 14, wherein the information on the scene includes, in association with a time point of a scene change, 1) at least one of a start time point of the scene and an end time point of the scene and 2) information on a difference between the end time point of the scene and the start time point of the scene, and
wherein the transmitting of the request for storing the scene in the scene library based on the information on the scene comprises:
receiving, based on the information on the scene, a user input associated with modification of at least one of the start time point of the scene and the end time point of the scene; and
transmitting a request for storing a modified scene in the scene library based on the user input to the server.

16. A non-transitory computer-readable storage medium storing instructions that, when executed by a processor, cause the processor to perform a method for analyzing a scene in a content streaming system, the method comprising:
receiving a request for generating a bookmark scene in a content image;
analyzing a target scene in the content image by image processing based on the request to generate the bookmark scene; and
storing the generated bookmark scene in a scene library.
